(19) United States
(12) Patent Application Publication
(10) Pub. No.: US 2026/0249754 A1
(43) Pub. Date: Aug. 27, 2026

(54) CAR SEAT WITH INERTIAL LOCK

(71) Applicant: Britax Child Safety, Inc., Fort Mill, SC (US)

(72) Inventor: Trent Cook, Fort Mill, SC (US)

(21) Appl. No.: 19/546,799

(22) Filed: Feb. 23, 2026

Related U.S. Application Data
(60) Provisional application No. 63/762,423, filed on Feb. 24, 2025.

(51) Int. Cl. B60N 2/28

(52) U.S. Cl. CPC B60N 2/2875; B60N 2/2821

(57) ABSTRACT

Systems and methods for a convertible car seat in accordance with embodiments of the invention are disclosed. In one embodiment, a convertible car seat includes a recline mechanism with an inertia lock mechanism.

### PRIORITY CLAIM AND CROSS-REFERENCE TO RELATED APPLICATION

The present application claims priority to and the benefit of U.S. Provisional Patent Application No. 63/762,423 filed Feb. 24, 2025, which is incorporated herein by reference in its entirety and relied upon.

### TECHNICAL FIELD

The present invention generally relates to child restraint systems, and more specifically to seats specially adapted for vehicles

### BACKGROUND

Car seats are designed to protect children in vehicles from the effects of impacts or sudden changes in motion (e.g., sudden acceleration, sudden deceleration, and the like).

Many car seats include recline mechanisms to allow the child to sit upright, or lean back, at a variety of angles. Current recline mechanisms present safety risks where, in the event of a sudden impact or crash, the recline mechanism could cause the child seat and the child to suddenly lunge forward or backward. In other words, an impact or crash could cause undesirable recline due to failure of the recline mechanism itself.

The present invention seeks to solve this issue by implementing an inertia lock mechanism into the child seat that is integrated with the recline mechanism.

### SUMMARY

Systems and methods for a car seat in accordance with embodiments of the invention are disclosed. In one embodiment, a car seat includes an outer shell having a seat portion, a back portion, and a base assembly having a mechanism for mounting the car seat and a recline mechanism. The recline mechanism includes an inertia lock mechanism which is designed to interact with the recline mechanism and other components of the convertible car seat.

In one embodiment a car seat comprises a recline mechanism and an inertia lock mechanism. The inertia lock mechanism interacts with the recline mechanism and the inertia lock is designed to be in an unlocked position or in a locked position.

In the second embodiment, the car seat comprises an inertia lock mechanism which includes a pivoting inertia lock, a ball, a pivot pin, and a ball seat.

In the third embodiment, the pivoting inertia lock comprises a hood and a pivoting inertia lock hole, wherein the hood is designed to fit over the ball, and the pivoting inertia lock hole is designed to receive the pivot pin.

In the fourth embodiment, the inertia lock mechanism is in the unlocked position when the ball rests in the ball seat and the hood hovers over the ball.

In a fifth embodiment, the inertia lock mechanism is in the locked position when the ball is not resting in the ball seat and the hood does not fit over the ball.

In a sixth embodiment, a car seat system comprises a recline mechanism and an inertia lock mechanism wherein the inertia lock mechanism interacts with the recline mechanism and wherein the inertia lock mechanism is designed to be in an unlocked position or in a locked position.

In a seventh embodiment, the inertia lock mechanism includes a pivoting inertia lock a ball a pivot pin and a ball seat.

In an eight embodiment, the pivoting inertia lock comprises a hood and a pivoting inertia lock hole, the hood is designed to fit over the ball, and the pivoting inertia lock hole is designed to receive the pivot pin.

In a ninth embodiment, the inertia lock mechanism is in the unlocked position when the ball rests in the ball seat and the hood fits over the ball.

In a tenth embodiment, the inertia lock mechanism is in the locked position when the ball does not rest in the ball seat and the hood does not fit over the ball.

In an eleventh embodiment, a method of locking a recline mechanism of a car seat comprising a recline mechanism and an inertia lock mechanism inertia lock, the method including exerting a force on the inertia lock, moving the inertia lock to interact with the recline mechanism, and locking the recline mechanism.

In a twelfth embodiment, the inertia lock mechanism is designed to be in an unlocked position or in a locked position.

In a thirteenth embodiment, the inertia lock mechanism includes a pivoting inertia lock, a ball, a pivot pin, and a ball seat.

In a fourteenth embodiment, the pivoting inertia lock comprises a hood and a pivoting inertia lock hole.

In a fifteenth embodiment, the hood is designed to fit over the ball.

In a sixteenth embodiment, the pivoting inertia lock hole is designed to receive the pivot pin.

In a seventeenth embodiment, the inertia lock mechanism is in the unlocked position when the ball rests in the ball seat and the hood fits over the ball.

In an eighteenth embodiment, the inertia lock mechanism is in the locked position when the ball does not rest in the ball seat and the hood does not fit over the ball.

In a nineteenth embodiment, including resetting the inertia lock mechanism.

In a twentieth embodiment, the recline mechanism is unlocked concurrent with resetting the inertia lock mechanism.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 shows a seat base of a car seat having a recline mechanism in accordance with an embodiment of the invention;

FIGS. 2A-B show a recline mechanism for a car seat in accordance with an embodiment of the invention;

FIGS. 3A-B show an inertia lock mechanism included in a recline mechanism for a car seat in accordance with an embodiment of the invention;

FIG. 4 shows a recline mechanism (which is illustrated as transparent for illustrative purposes) including an inertia lock mechanism for a convertible car seat in accordance with an embodiment of the invention;

FIG. 5 shows a pivoting inertia lock; and

FIGS. 6A-B show an inertia lock mechanism.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Turning now to the drawings, systems and methods for a car seat in accordance with embodiments of the inventions are disclosed. The car seat referenced herein is generally a car seat used for children. It should be appreciated that the car seat includes two modes of operation, rear-facing and forward-facing. In the rear-facing mode, the car seat can be used for newborn and toddlers. In the forward-facing mode, the car seat can be used for children that fit the height and weight requirements.

While it is important for a car seat to be properly secured to a vehicle (e.g., vehicle seat or underlying structure) to protect the child, it is also important that the car seat be properly sized and configured to support the child correctly and provide maximum protection in the event of an impact. As a child grows, their proportions change rapidly in the early years of life and any selected seat configuration will be quickly outgrown as the child develops. For example, in early infancy a child's bones are supple and capable of more flexure than those of an adult; however, their head and neck are particularly vulnerable to impact or sudden directional changes in momentum as the head is large and the supporting musculature of the neck is still developing. Further, children have various amounts of head control. Generally, older children have increased head control and can tolerate a more upright position in a car seat. Thus, ensuring that the convertible car seat is in the correct inclined position will support the child both for everyday comfort and for an impact event.

Car seats in accordance with embodiments of the invention include a recline mechanism. The recline mechanism allows a user to adjust the angle of the car seat relative to the base. By allowing a user to adapt the angle of the car seat to the child, a car seat provides added comfort and safety for an impact event. For example, with a rear-facing car seat, a car seat in an upright position could contact the vehicle seat back. A car seat at an inclined position could provide the child with additional leg space between the car seat and the vehicle seat back.

Recline mechanisms in accordance with embodiments of the invention include an inertial lock mechanism. The inertia lock mechanism interacts with the components of the car seat such as the recline mechanism to restrict movement of the car seat such as reclining in the event of an impact. By allowing a user to block the movement the car seat such as of the recline mechanism, a car seat provides added safety for if there is an impact. For example, in a collision or sudden acceleration/deceleration, the inertia lock will stop the car seat from suddenly reclining and resulting in further injury.

Systems and methods for recline mechanisms with an inertia lock mechanism in accordance with embodiments of the invention are described in more detail below.

In a variety of embodiments, a base assembly of a convertible car seat incorporates a recline mechanism. The recline mechanism allows a user to adjust the angular inclination of the seating portion of the car seat, relative to the base assembly.

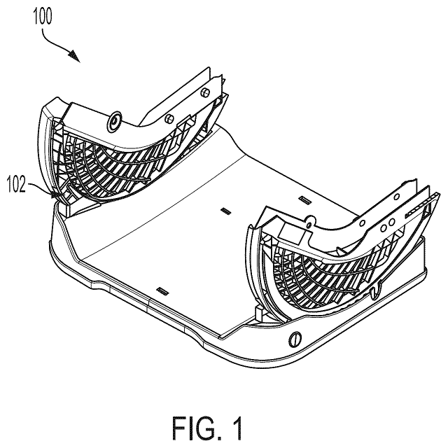

FIG. 1 shows a recline mechanism for a car seat in accordance with an embodiment of the invention. In various embodiments, the recline adjustment handle can have a variety of shapes. For example, the recline adjustment handle can have a continuous structure defining a parabola or other curve. The recline mechanism 100 permits a user to unlock the car seat and adjust the incline of the seating portion of the convertible car seat relative to the base assembly; the recline mechanism 100 then permits the user to lock the car seat and secure the incline of the seating portion of the convertible car seat relative to the base assembly.

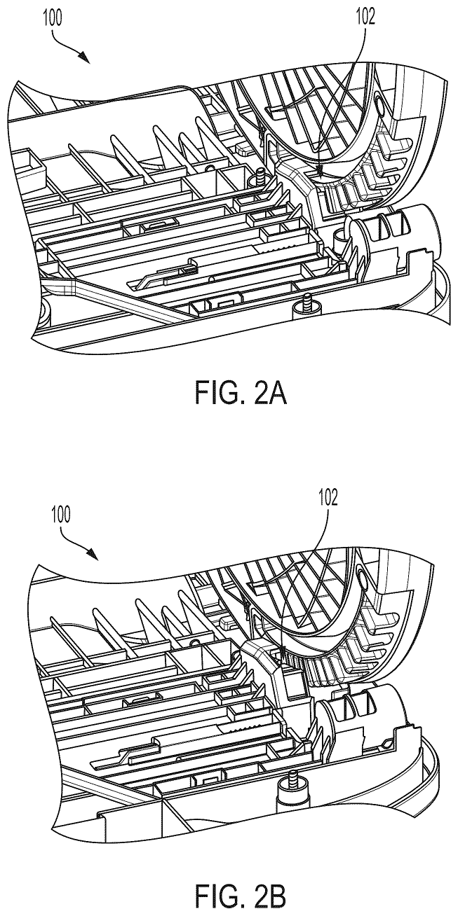

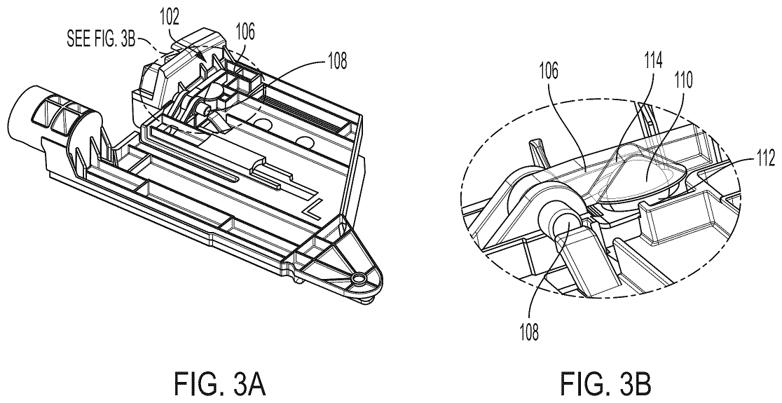

FIGS. 2A-B show a recline mechanism 100 for a car seat in accordance with an embodiment of the invention. Specifically, FIG. 2A illustrates the recline mechanism 100 in the locked position and FIG. 2B illustrates the recline mechanism in the unlocked position. In the locked position, the inertia lock mechanism 102 (illustrated in more detail in FIG. 3) prevents a user from using the recline mechanism 100. As detailed above, the inertia lock mechanism 102 interacts with the recline mechanism 100 of the child seat as well as various other embodiments of the child seat. Namely, the inertia lock mechanism 102 moves from an unlocked position to a locked position when a force is exerted on the car seat, such as the force stemming from a car crash or sudden acceleration/deceleration. When the inertia lock mechanism 102 is disposed in the locked position, the inertia lock mechanism 102 prevents the movement of the recline mechanism 100 and/or other components of the child seat. In other words, the inertial lock mechanism 102 prevents a user from adjusting the incline of the car seat when the inertial lock mechanism 102 is disposed in the locked position. This provides additional safety benefits in the event of an impact or any outside sudden force.

FIGS. 3A-B show the inertia lock mechanism 102 disposed in the unlocked position. In an unlocked position, the user is free to utilize the recline mechanism 100. FIG. 3A depicts a front perspective view of the inertia lock mechanism 102 and FIG. 3B depicts a zoomed in view of the inertia lock mechanism 102. Turning to FIG. 3A, the inertia lock mechanism 102 includes a pivoting inertia lock 106, a pivot pin 108, a ball 110, and a ball seat 112. The pivoting pin 108 is affixed to a portion of the car seat and the pivoting inertia lock 106 is attached to the pivoting pin 108. The ball seat 112 typically configured as an aperture along a surface of the car seat. The ball seat 112 is dimensioned such that the ball 110 can rest inside the ball seat 112. Namely, for example, the diameter of ball 110 is less than that of the diameter of ball seat 112, such that ball 110 has the ability to translate and/or roll within ball seat 112.

Moving to FIG. 3B, which illustrates the pivoting inertia lock 106 as translucent for illustrative purposes. The inertia lock mechanism 102 includes the pivoting inertia lock 106, the pivot pin 108, the ball 110, and the ball seat 112. The pivot pin 108 is attached to one end of the pivoting inertia lock 106 and the other end of the pivoting inertia lock 106 includes a hood 114. The hood 114 is designed such that the hood 114 fits over the ball 110. The ball 110 sits or nests in the ball seat 112. For example, the diameter of ball 110 is less than that of the diameter of hood 114. In an embodiment, hood 114 and ball seat 112 are of analogous dimensions, so as to form a sphere when disposed adjacent to one another; ball 110 would be disposed within this purported sphere. As shown in FIG. 3B when the inertia lock mechanism 102 is in the unlocked position, the ball 110 is sits or nests in the ball seat 112. The ball 110 can be comprised of metal or another durable material. Of note, the ball 110 must have a mass configured to respond to changes in inertial force.

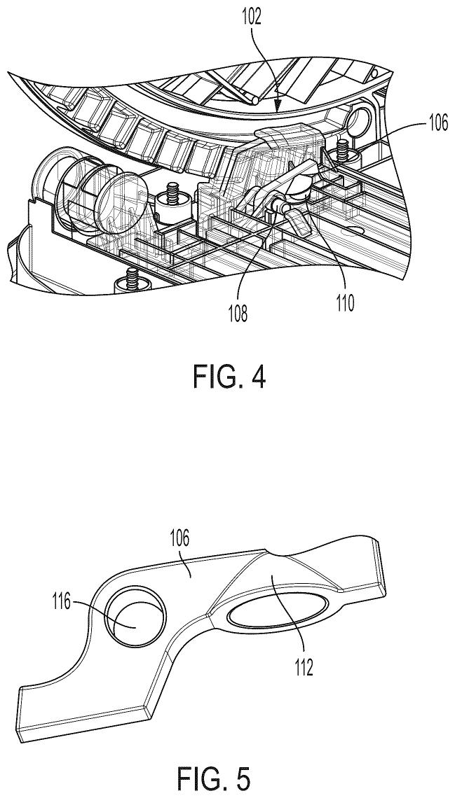

FIG. 4 shows a recline mechanism 100, which is illustrated as transparent for illustrative purposes, including an inertia lock mechanism 102 for a car seat in accordance with an embodiment of the invention. The inertia lock mechanism 102 is designed to interact with various components of the car seat. Preferably, the inertia lock mechanism 102 at least interacts with the recline mechanism 100 of the car seat. However, the inertia lock mechanism 102 can also interact with additional other components such as a rotation mechanism 100. Specifically, the geometry of the inertia lock mechanism 102 has a mating or reciprocal relationship with the recline mechanism 100 such that when the inertia lock mechanism 102 moves to a locked configuration, the inertia lock mechanism 102 mechanically blocks the recline mechanism 100, as further detailed below.

FIG. 5 shows the pivoting inertia lock 106 of the inertia lock mechanism 102. The pivoting inertia lock 106 includes a pivoting inertia lock hole 116 and a ball seat 112. The pivoting inertia lock hole 116 is designed such that the pivot pin 108 (not shown) can be inserted or received by the pivoting inertia lock hole 116. As such, when the pivoting inertia lock 106 couples a seat, seat base, or other component, the inertia lock hole 116 and pivot pin 108 provide a pivoting point for the pivoting inertia lock 106. In turn, the pivoting inertia lock 106 pivots when the ball 110 (not shown) moves and, therefore determines whether the inertia lock mechanism 102 is in a locked or unlocked position.

The ball seat 112 is designed such that the ball seat 112 can be disposed on the ball 110 (not shown) in an unlocked position. The pivoting inertia lock 106 can be in a variety of shapes and designs and can be made of a variety of materials such as metals or plastics. The pivoting inertia lock hole 116 can be a variety of shapes. Preferably, the pivoting inertia lock hole 116 is a same or similar shape as the circumference of the pivot pin 108.

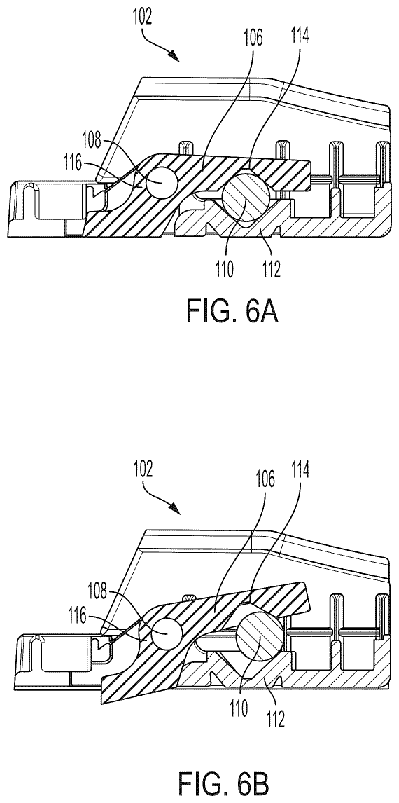

FIGS. 6A-B illustrates a side view of an inertia lock mechanism 102. FIG. 6A illustrates the inertia lock mechanism 102 in an unlocked position. FIG. 6B illustrates the inertia lock mechanism 102 in a locked position. Turning to FIG. 6A, the inertia lock mechanism 102 includes a pivoting inertia lock 106, pivot pin 108, ball 110, and ball seat 112. The pivoting inertia lock 106 comprises a hood 114 and a pivoting inertia lock hole 116. The pivoting inertia lock hole 116 is deigned such that the pivot pin 108 can be inserted into the pivoting inertia lock hole 116. The pivot pin 108 is pivotally coupled to the car seat base. The hood 116 is designed such that the hood 114 can rest on top of the ball 110. The inertia lock mechanism 102 is in the locked position. In the locked position, the ball 110 is resting in the ball seat 112 and the hood 114 is resting over the ball 110.

Moving to FIG. 6B, the inertia lock mechanism 102 is now disposed in a locked position. For the inertia lock mechanism 102 to move from an unlocked to a locked position, the car seat must encounter an impact, which creates a force on the car seat. When the force creates an impact on the car seat, the inertia lock mechanism 102 will be activated. When the inertia lock mechanism 102 is activated, the ball 110 is displaced from the seat 112 and the hood 114. The force from the displacement of the ball 110 causes the inertia lock 106 to pivot about the pivot pin 108, which is pivotally coupled to the car seat base. As the inertial lock 106 pivots, it interlocks with components on the recline mechanism 100. The interlocking relationship prevents the recline mechanism 100 from activating by blocking movement of the recline mechanism 100. As such, the pivoting action from the inertial lock 106 prevents unwanted reclining in situations where the car seat experiences a force over a certain threshold. Of note, the geometry of the inertia lock mechanism 102 is configured such that it will only activate and move to a locked configuration when predefined inertial thresholds are met. As such, this prevents undesired inertia lock mechanism 102 activations in situations where the child seat experiences standard gravitational forces, such as common car stop and go.

Moreover, in one embodiment, after experiencing an inertial for leading to a locked configuration, the ball 110 automatically reverts back into the ball seat 112, so as to allow the pivoting inertia lock 106 to pivot back to an unlocked position and, thereby, ‘resetting’ the inertia lock mechanism 102 automatically. This would mean that the inertia lock mechanism 102 locks in a collision event to prevent undesired recline, but then reverts to original state. In an alternate embodiment, not shown, the inertia lock mechanism 102 may further comprise a reset component that the user can actuate after the inertia lock mechanism 102 is in the locked configuration. The reset component would re-orient the ball 110 into the ball seat, such that the pivoting inertial lock 106 returns to an unlocked configuration, wherein the recline mechanism 100 can be activated.

Although the present invention has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

What is claimed is:

1. A car seat comprising:
a recline mechanism; and
an inertia lock mechanism,
wherein the inertia lock mechanism interacts with the recline mechanism and wherein the inertia lock mechanism is designed to be in an unlocked position or in a locked position.

2. The car seat of claim 1, wherein the inertia lock mechanism comprises:
a pivoting inertia lock;
a ball;
a pivot pin; and
a ball seat.

3. The car seat of claim 2, wherein the pivoting inertia lock comprises a hood and a pivoting inertia lock hole, wherein the hood is designed to fit over the ball, and the pivoting inertia lock hole is designed to receive the pivot pin.

4. The car seat of claim 3, wherein the inertia lock mechanism is in the unlocked position when the ball rests in the ball seat and the hood fits over the ball.

5. The car seat of claim 3, wherein the inertia lock mechanism is in the locked position when the ball does not rest in the ball seat and the hood does not fit over the ball.

6. A car seat system comprising:
a recline mechanism; and
an inertia lock mechanism,
wherein the inertia lock mechanism interacts with the recline mechanism and wherein the inertia lock mechanism is designed to be in an unlocked position or in a locked position.

7. The car seat system of claim 6, wherein the inertia lock mechanism comprises:
a pivoting inertia lock;
a ball;
a pivot pin; and
a ball seat.

8. The car seat system of claim 7, wherein the pivoting inertia lock comprises a hood and a pivoting inertia lock hole, wherein the hood is designed to fit over the ball, and the pivoting inertia lock hole is designed to receive the pivot pin.

9. The car seat system of claim 8, wherein the inertia lock mechanism is in the unlocked position when the ball rests in the ball seat and the hood fits over the ball.

10. The car seat system of claim 8, wherein the inertia lock mechanism is in the locked position when the ball does not rest in the ball seat and the hood does not fit over the ball.

11. A method of locking a recline mechanism of a car seat comprising a recline mechanism and an inertia lock mechanism inertia lock, the method comprising:
exerting a force on the inertia lock,
moving the inertia lock to interact with the recline mechanism, and
locking the recline mechanism.

12. The method of claim 11, wherein the inertia lock mechanism is designed to be in an unlocked position or in a locked position

13. The method of claim 12, wherein the inertia lock mechanism comprises:
a pivoting inertia lock;
a ball;
a pivot pin; and
a ball seat.

14. The method of claim 13, wherein the pivoting inertia lock comprises a hood and a pivoting inertia lock hole.

15. The method of claim 14, wherein the hood is designed to fit over the ball.

16. The method of claim 14, wherein the pivoting inertia lock hole is designed to receive the pivot pin.

17. The method of claim 15, wherein the inertia lock mechanism is in the unlocked position when the ball rests in the ball seat and the hood fits over the ball.

18. The method of claim 15, wherein the inertia lock mechanism is in the locked position when the ball does not rest in the ball seat and the hood does not fit over the ball.

19. The method of claim 11, further comprising resetting the inertia lock mechanism.

20. The method of claim 19, wherein the recline mechanism is unlocked concurrent with resetting the inertia lock mechanism.
